(19) United States
(12) Patent Application Publication
(10) Pub. No.: US 2024/0340050 A1
(43) Pub. Date: Oct. 10, 2024

(54) PHYSICAL RESOURCE BLOCK ALLOCATION ALIGNMENT

(71) Applicant: QUALCOMM Incorporated, San Diego, CA (US)

(72) Inventors: Roberto AIROLDI, Helsinki (FI); Shmuel VAGNER, San Diego, CA (US); Deepak AGARWAL, San Diego, CA (US); Michael Francis GARYANTES, Bradley Beach, NJ (US); Abhishek Saurabh SACHIDANAND SINHA, San Diego, CA (US); Osama ALRABADI, Nurnberg (DE); Jigneshkumar SHAH, San Diego, CA (US)

(21) Appl. No.: 18/437,921

(22) Filed: Feb. 9, 2024

Related U.S. Application Data
(60) Provisional application No. 63/494,412, filed on Apr. 5, 2023.

(51) Int. Cl. H04B 7/06; H04B 7/024; H04L 5/00; H04W 72/27

(52) U.S. Cl. CPC H04B 7/0617; H04B 7/024; H04L 5/0035; H04W 72/27

(57) ABSTRACT

Certain aspects of the present disclosure provide techniques for physical resource block allocation alignment. An example method, performed at a first network entity, includes transmitting beamforming weights (BFWs) to a second network entity, each beamforming weight to be applied to a different bundle of one or more physical resource blocks (PRBs), transmitting, to the second network entity, one or more parameters indicative of a misalignment between an allocation of PRBs and at least one logical structure, and processing signals transmitted between the first and second network entities, with beamforming applied to PRB bundles using the BFWs, in accordance with the one or more parameters.

### CROSS-REFERENCE TO RELATED APPLICATION(S)

This application claims benefit of and priority to U.S. Provisional Application No. 63/494,412, filed Apr. 5, 2023, which is assigned to the assignee hereof and hereby expressly incorporated by reference in its entirety as if fully set forth below and for all applicable purposes.

### BACKGROUND

### Field of the Disclosure

Aspects of the present disclosure relate to wireless communications, and more particularly, to techniques for aligning beamforming weights with physical resource block allocations.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communications at a first network entity. The method includes transmitting beamforming weights (BFWs) to a second network entity, each beamforming weight to be applied to a different bundle of one or more physical resource blocks (PRBs); transmitting, to the second network entity, one or more parameters indicative of a misalignment between an allocation of PRBs and at least one logical structure; and processing signals transmitted between the first and second network entities, with beamforming applied to PRB bundles using the BFWs, in accordance with the one or more parameters.

Another aspect provides a method of wireless communications at a second network entity. The method includes receiving BFWs from a first network entity, each beamforming weight to be applied to a different bundle of one or more PRBs; receiving, from the second network entity, one or more parameters indicative of a misalignment between an allocation of PRBs and at least one logical structure; and processing signals transmitted between the first and second network entities, with beamforming applied to PRB bundles using the BFWs, in accordance with the one or more parameters.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example description of lower layer uplink link split between O-RAN Distributed Unit (O-DU) and O-RAN Radio Unit (O-RU).

FIG. 6 depicts an example specification for functional splitting between O-DU and O-RU.

FIGS. 7-10 illustrate examples of potential misalignment between BFWs to PRBs.

FIG. 11 is an example call flow diagram, in accordance with aspects of the present disclosure.

FIG. 12 is another example call flow diagram, in accordance with aspects of the present disclosure.

FIG. 13 illustrates an example of parameters that may be used to align BFWs to PRBs, in accordance with aspects of the present disclosure.

FIG. 13A illustrates another example of parameters that may be used to align BFWs to PRBs, in accordance with aspects of the present disclosure.

FIGS. 14-19 illustrate examples of how to align BFWs to PRBs, in accordance with aspects of the present disclosure.

FIG. 20 depicts a method for wireless communications.

FIG. 21 depicts a method for wireless communications.

FIG. 22 depicts aspects of an example communications device.

FIGS. 23-25 illustrate examples of how to align BFWs to PRBs, in accordance with aspects of the present disclosure

### DETAILED DESCRIPTION

Aspects of the present disclosure provide apparatuses, methods, processing systems, and computer-readable mediums for techniques that may help align beamforming weights with physical resource blocks (PRBs).

Deployment of communication systems, such as 5G new radio (NR) systems, may be arranged in multiple manners with various components or constituent parts. In such systems, a network entity, such as a base station (BS), or one or more units (or one or more components) performing base station functionality, may be implemented in a disaggregated architecture. For example, a disaggregated base station may be configured to utilize a protocol stack that is physically or logically distributed among two or more units (such as one or more central or centralized units (CUs), one or more distributed units (DUs), or one or more radio units (RUs)).

In some cases, disaggregated base stations may be utilized in an open radio access network (O-RAN (such as the network configuration sponsored by the O-RAN Alliance)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

O-RAN specifies control plane, user plane and synchronization plane protocols used over the fronthaul interface linking the O-DU (O-RAN Distributed Unit) with the O-RU (O-RAN Radio Unit) with a Lower Layer Functional Split (e.g., Functional Split-7-2×) based architecture. As used herein, the term functional split generally refers to how (e.g., gNB) functionality is divided between network entities (O-DUs and O-RUs).

One potential area of interest is the impact of uplink performance for various Lower Layer Split functional division between O-DU and O-RU, particularly for physical uplink shared channel (PUSCH) transmissions in systems involving many antennas, such as massive multiple input-multiple output (MIMO) use cases. Conventionally, beam-forming weights for uplink transmissions are based on sounding reference signal (SRS) based channel estimates. At the O-DU, on the other hand, channel estimation based on demodulation reference signals (DMRS) is applied for demodulation.

Beamforming weights (BFWs) are typically used to optimize fronthaul (FH) transmissions from the O-RU to the O-DU. A data structure referred to as a Type 11 Extension section (or simply Extension 11) provides a flexible mechanism for sending beamforming weights from the O-DU to the O-RU. This enables the O-DU to provide different beamforming weights for different PRBs, when transmitting on the fronthaul (FH). Each beamforming weight (signaled via an Extension 11 section) is typically applied to a bundle of PRBs. A size of the bundle of PRBs, that share a same beamforming weight, is determined by a parameter referred to as a numBundPrb parameter.

Some potential issues exist when determining what beamforming weights to apply to which PRBs. For example, in some cases, PRB bundle may not align with a precoding resource block group (PRG) size or a static beamforming grid when the numBundPrb is larger than one. In the case of narrow band scenarios, where a PRG size is 2 or 4, PRG and beam boundaries may be aligned so that beams cannot cross PRG boundaries. In this case, there may be an issue determining what beamforming weight to apply to PRBs in a first BF bundle that does not align with PRG or beam boundaries.

One potential solution would be to set allocations to ensure so that no section can start unaligned to a PRG/static beam. This approach, however, would result in more signaling overhead, in the form of more sections to be processed, more complexity, and more processing overhead. Another potential solution would be to fix the parameter numBundPrb to a value of one and repeat signaling of beamforming weights (BFWs) and beamIds (for each PRB). Unfortunately, this would mean sending redundant information on the fronthaul (when the same beamforming weight is applied to multiple PRBs).

Aspects of the present disclosure, however, provide an alternative solution to help accurately associate beamforming weights with PRBs. For example, according to certain aspects, an O-DU may signal (to an O-RU) one or more parameters that may allow the O-RU to align beamforming weights with PRBs. For example, the parameters may include a first parameter that indicates a precoding resource block group (PRG) size and a second parameter that indicates an offset between a first allocated PRB and a start of a PRG or PRB bundle that contains the first allocated PRB. The O-RU may use the parameters to compute a misalignment between an allocation of PRBs and a PRG or a grid that maps beamforming weights to PRBs.

As a result, aspects of the present disclosure may lead to more accurate application of beamforming weights, which may result in improved overall performance.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

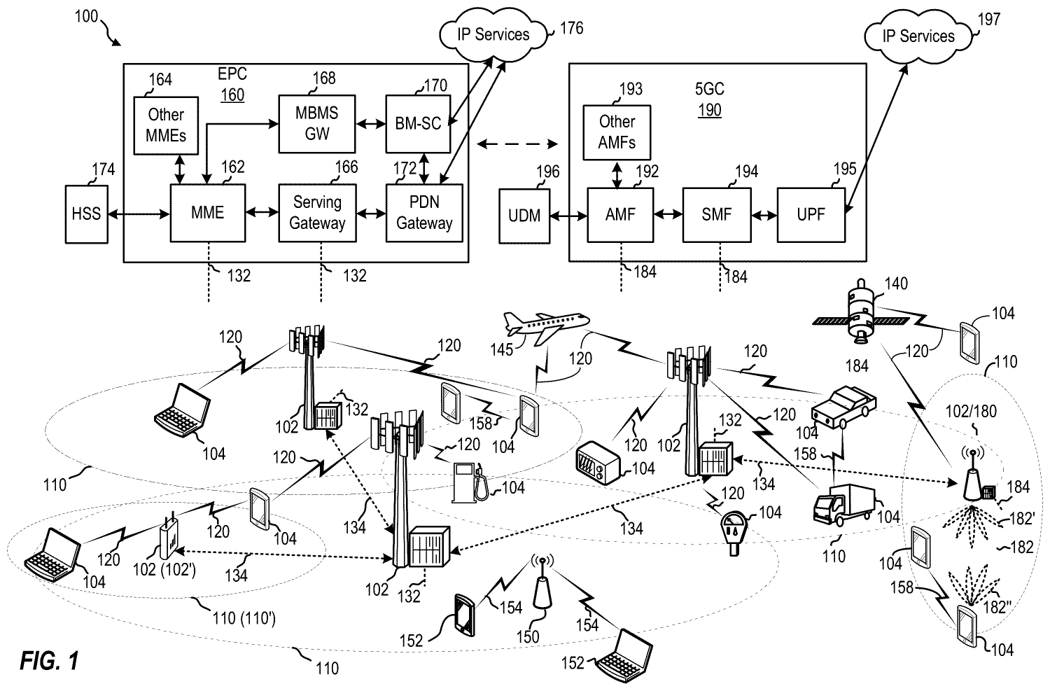

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

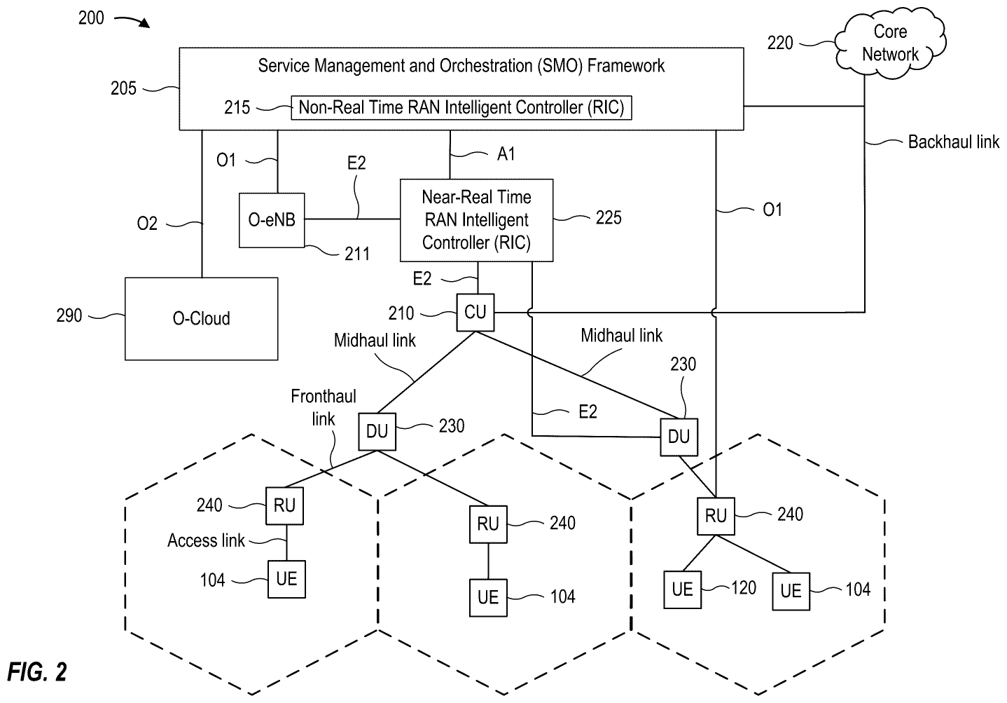

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) arca broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-cNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

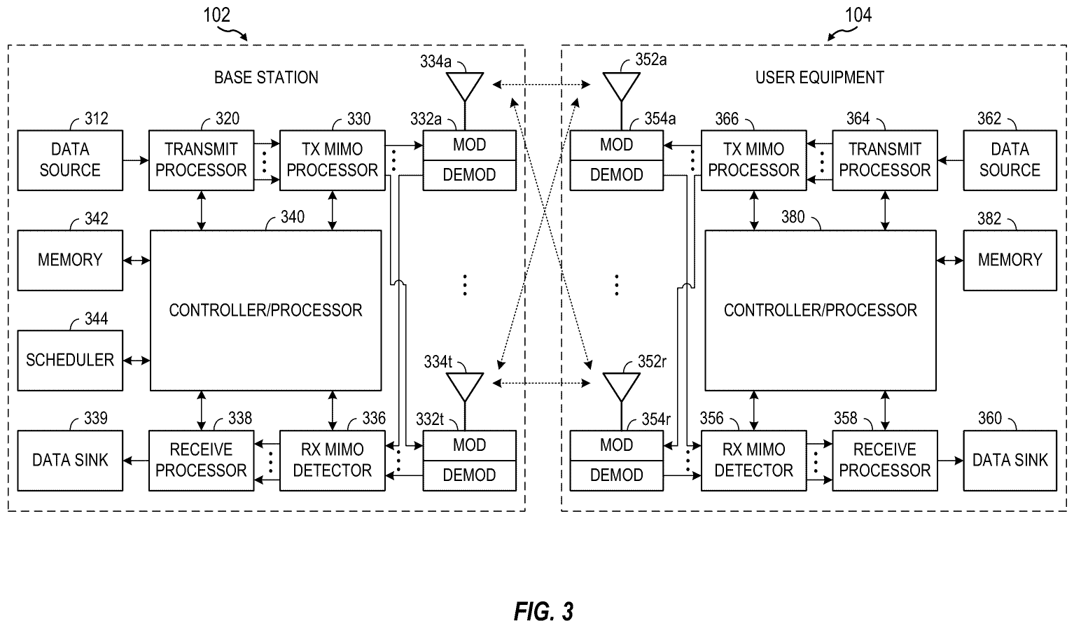

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

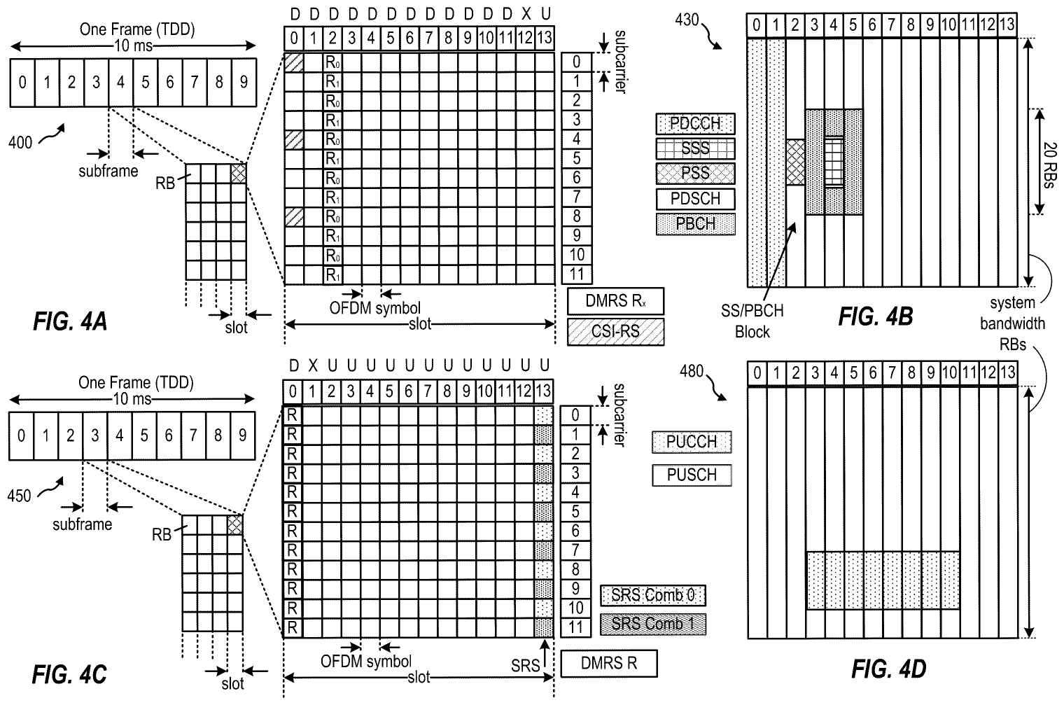

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology u=0 has a subcarrier spacing of 15 kHz and the numerology u=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Beamforming Weight Computation in O-RAN

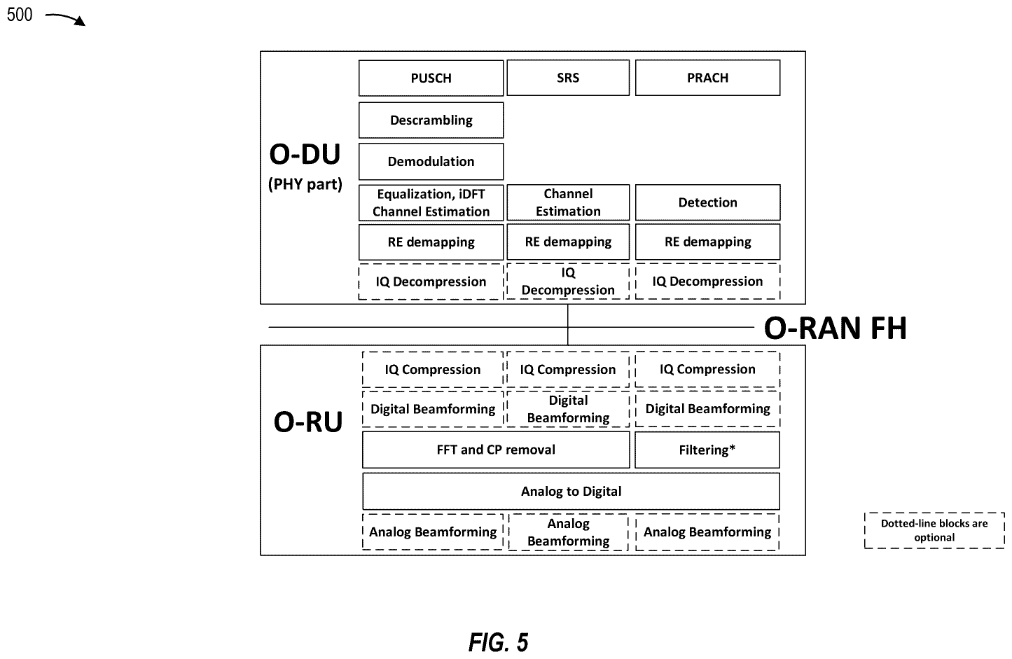

As noted above, O-RAN specifies control plane, user plane and synchronization plane protocols used over the fronthaul interface linking the O-DU (O-RAN Distributed Unit) with the O-RU (O-RAN Radio Unit) with a Lower Layer Functional Split based architecture. FIG. 5 illustrates an example of an O-RAN architecture 500 implementing such as split for uplink transmissions, sent from an O-RU to an O-DU via a fronthaul (FH) interface.

In certain cases, current specified functional splits may be less than ideal and may result in degraded performance in scenarios, such as massive MIMO (mMIMO), mobility, or interference scenarios. Aspects of the present disclosure may help address this potential issue and may help improve performance in such scenarios. In some cases, the techniques proposed herein may allow for what is effectively a backward-compatible variant of a (7-2× functional split) fronthaul interface to allow an enhancement of the UL air interface performance, especially in the case of mMIMO.

As noted above, beam-forming weights for uplink transmissions are conventionally based on sounding reference signal (SRS) channel estimates, while channel estimation based on demodulation reference signals (DMRS) is applied for demodulation.

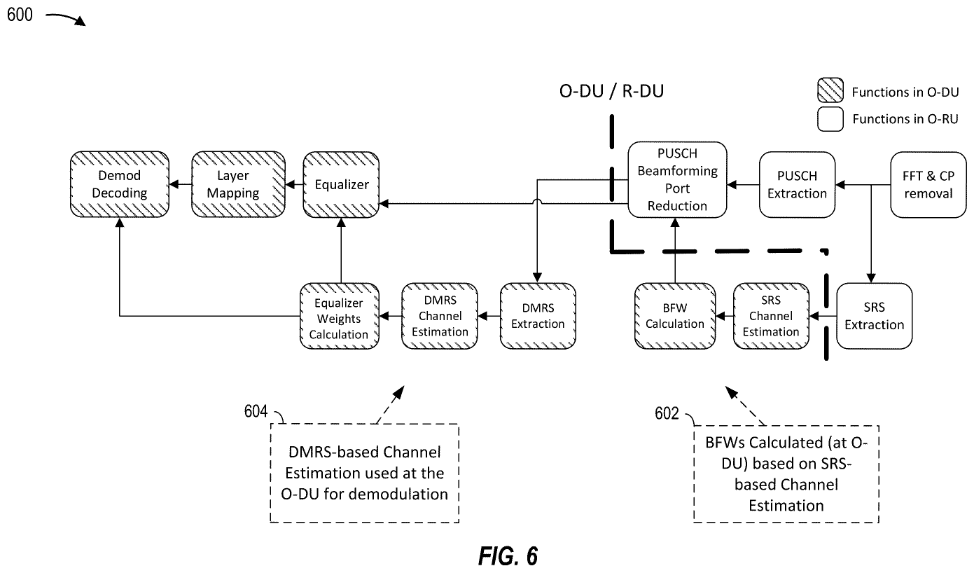

An example 600 of this approach is shown in FIG. 6. As noted at 602, beamforming weights (BFWs), calculated at the O-DU based on SRS-based channel estimation, are applied at the O-RU. As noted at 604, at the O-DU, channel estimation based on DMRS is applied for demodulation.

As noted above, for codebook-based uplink transmissions, the gNB indicates a Transmitted Precoding Matrix Indication (TPMI) to a UE, the selection of which may be performed by a TPMI selection component at the O-DU. This TPMI selection component may be implemented at certain layer, referred to as L1-High (layer one high), at the O-DU.

### Aspects Related to Physical Resource Block Allocation Alignment

Aspects of the present disclosure provide apparatuses, methods, processing systems, and computer-readable mediums for techniques that may help align beamforming weights with physical resource blocks (PRBs).

As noted above, beamforming weights (BFWs) are typically used to optimize fronthaul (FH) transmissions from the O-RU to the O-DU. An Extension 11 provides a flexible mechanism for sending multiple beamforming weights from the O-DU to the O-RU. This enables the O-DU to provide different beamforming weights for different PRBs (rather than sending a single beamforming weight per PRB in a single section). Each of the indicated beamforming weights is typically applied to a bundle of PRBs, the size of which is indicated by the numBundPrb parameter. This parameter is the number of bundled PRBs per beamforming weight sets. In other words, the numBundPrb parameter informs the O-RU how many PRBs are bundled together and share the same beamforming weights.

As noted above, a PRB bundle size greater than one may result in misalignment between a PRB bundle and a PRG size or static beamforming grid. Some potential issues exist when determining what beamforming weights to apply to which PRBs when a PRB bundle does not align with a precoding resource block group (PRG) size or a static beamforming grid.

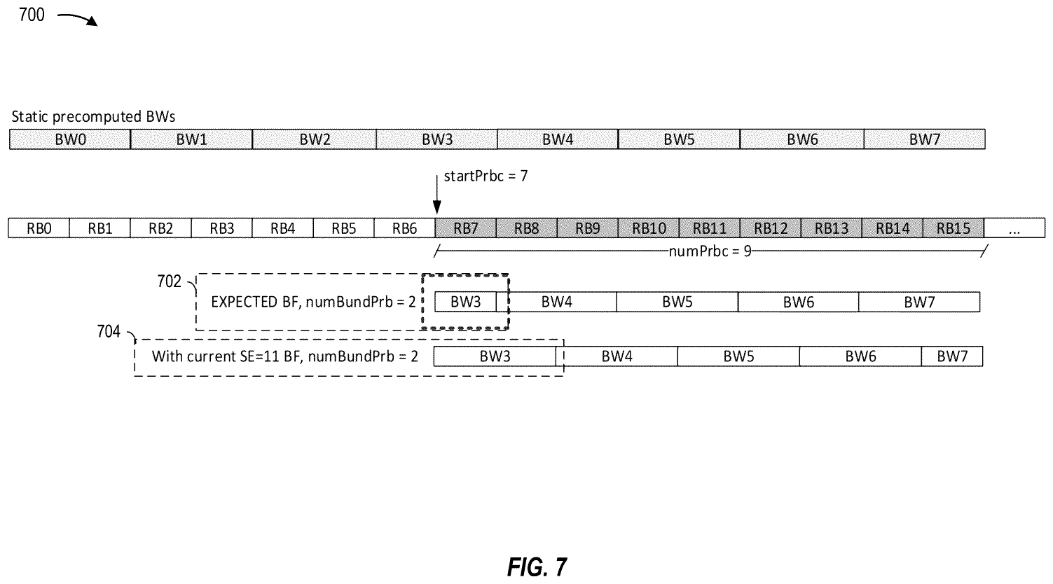

One example of this misalignment is illustrated in the diagram 700 of FIG. 7. The illustrated example assumes static (pre-computed) beamforming weights (BW0-BW7) an allocation that starts at RB7 (startPrbc=7), and a PRB bundle size of 2 (as indicated by the numBundPrb parameter).

As illustrated at 702, the expected beamforming weight to be applied to RB7 may be BW3, as RB7 falls within BW3 of the beamforming weight grid, while the next two RBs (RB8 and RB9) fall within BW4. As indicated at 704, however, beamforming weights indicated in conventional section extension (SE) type 11 (SE=11) begin at the starting RB (RB7), but the bundle size of 2 will result in misalignment with the beamforming grid. As a result, BW3 may also be applied to RB8, rather than the expected BW4, which may impact beamforming performance.

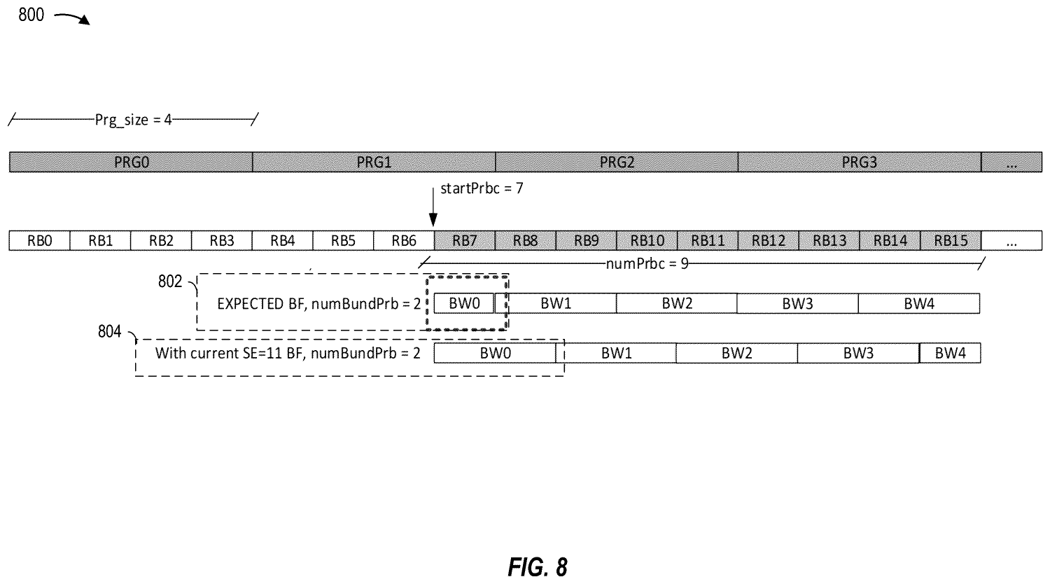

An example of misalignment with a PRG is illustrated in the diagram 800 of FIG. 8. The illustrated example again assumes an allocation that starts at RB7, a PRB bundle size of 2, and a PRG size of 4 (each PRG has 4 RBs).

As illustrated at 802, the expected beamforming weight (BW) to be applied to RB7 (that falls within PRG1) is BW0, while the expected BW to be applied to RB8 (that falls within PRG2) is BW1. As indicated at 804, however, the BWs indicated SE 11 begin at the starting RB (RB7), but the bundle size of 2 will result in misalignment with the PRG boundaries. As a result, BW0 may also be applied to RB8, rather than the expected BW1, again impacting beamforming performance.

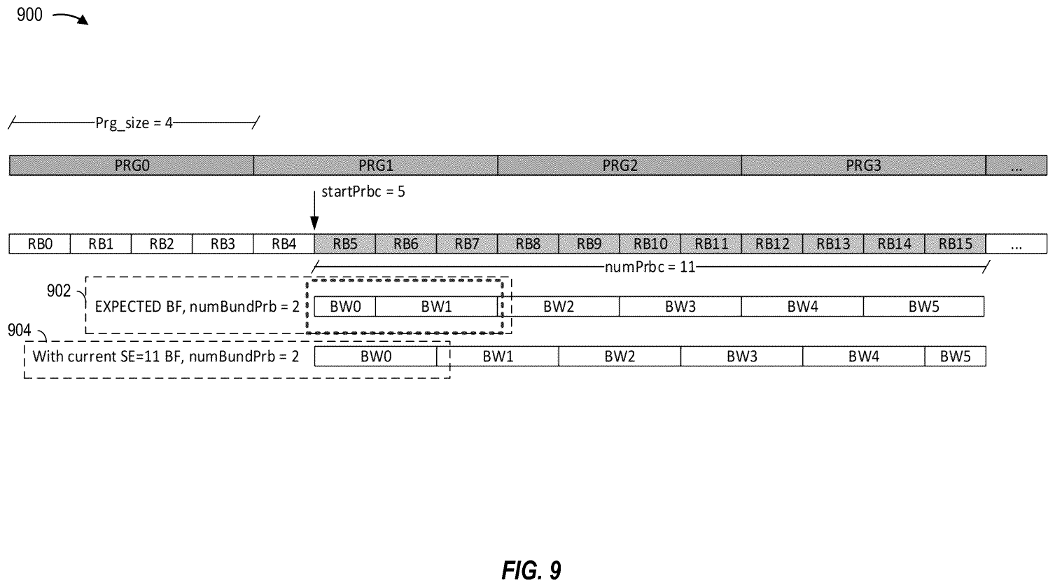

Another example of misalignment with a PRG is illustrated in the diagram 900 of FIG. 9. The illustrated example assumes an allocation that starts at RB5 (startPrbc=5), a PRB bundle size of 2, and a PRG size of 4.

As illustrated at 902, the expected BW to be applied to RB5 (that falls within PRG1) is BW0, while the expected BW to be applied to RB6 and RB7 (that also fall within PRG1) is BW1. As indicated at 904, however, the BWs indicated SE 11 begin at the starting RB (RB5), but the bundle size of 2 will result in misalignment with the PRG boundaries. As a result, BW0 may also be applied to RB6, rather than the expected BW1.

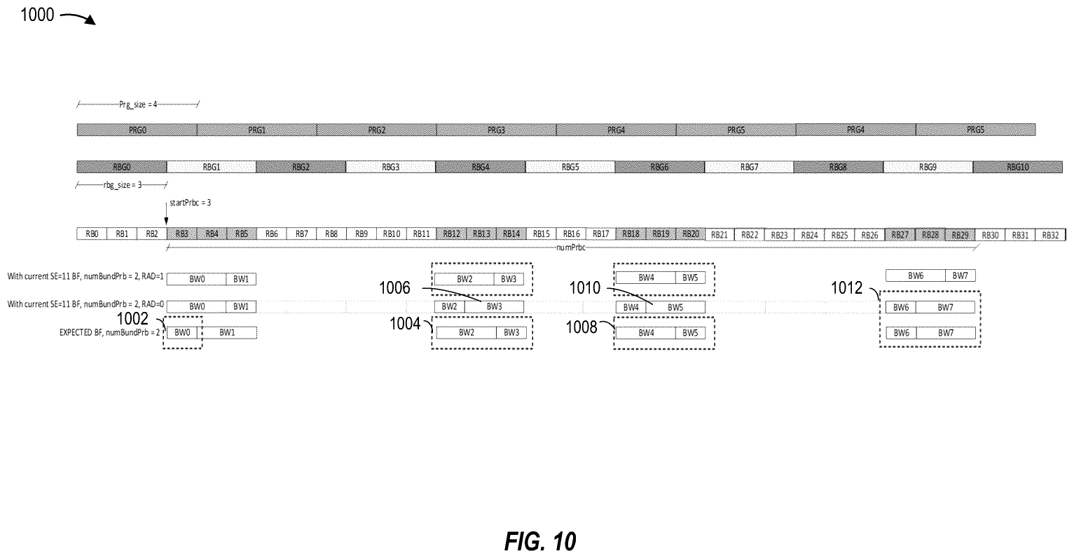

Misalignment may also impact beamforming association when there are discontinuities in the RB allocation, for example, when using section extension 6 (SE=6). An example of misalignment when there are such discontinuities is illustrated in the diagram 1000 of FIG. 10. The illustrated example assumes a PRB bundle size of 2, a PRG size of 4, and discontinuous resource block group (RBG) allocations (with an RBG size of 3 RBs) that start at RB3, RB12, RB18, and RB27.

As illustrated at 1002, the expected BW to be applied to RB3 is BW0, while the expected BW to be applied to RB4 and RB5 is BW1. With current SE 11, with discontinuity (as indicated by a Reset After PRB Discontinuity (RAD)=0), BW0 is also applied to RB4 (rather than BW1). As illustrated at 1004, the expected BW to be applied to RB12 and RB13 is BW2, while the expected BW to be applied to RB14 is BW3. With current SE 11, as shown at 1006, with discontinuity (RAD=0), BW3 is also applied to RB13 (rather than BW2). As illustrated at 1008, the expected BW to be applied to RB18 and RB19 is BW4, while the expected BW to be applied to RB20 is BW5. With current SE 11, as shown at 1010, with discontinuity (RAD=0), BW5 is also applied to RB19 (rather than BW4). As illustrated at 1012, for the allocation starting at RB27, the expected result is achieved with SE 11 (with RAD=0), with BW6 applied to RB27 and BW7 applied to RB28 and RB29.

Aspects of the present disclosure provide signaling mechanisms that may help accurately associate beamforming weights with PRBs. According to certain aspects, an O-DU may signal (to an O-RU) one or more parameters that may allow the O-RU to align beamforming weights with PRBs.

For example, the parameters may include a first parameter that indicates a precoding resource block group (PRG) size and a second parameter that indicates an offset between a first allocated PRB and a start of a PRG or PRB bundle that contains the first allocated PRB. The O-RU may use the parameters to compute a misalignment between an allocation of PRBs and a PRG or a grid that maps beamforming weights to PRBs. As a result, aspects of the present disclosure may lead to more accurate application of beamforming weights, which may result in improved overall performance.

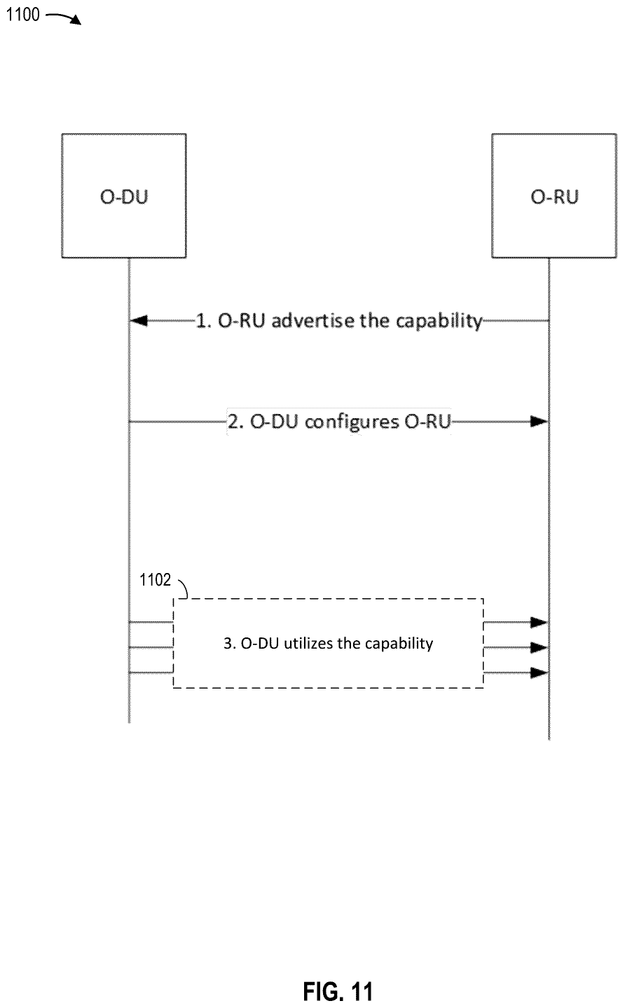

In some cases, as illustrated in the call flow diagram 1100 of FIG. 11, an O-RU may first signal (advertise) its capability to support the BFW alignment techniques proposed herein. Based on the advertised capability, the O-DU may configure the O-RU accordingly. For example, the O-DU may send an Extension 11 with BWFs and the parameters noted above used to compute the misalignment between the allocation of PRBs and a PRG or BF grid. As shown at 1102, the O-DU (and O-RU) may then utilize the capability.

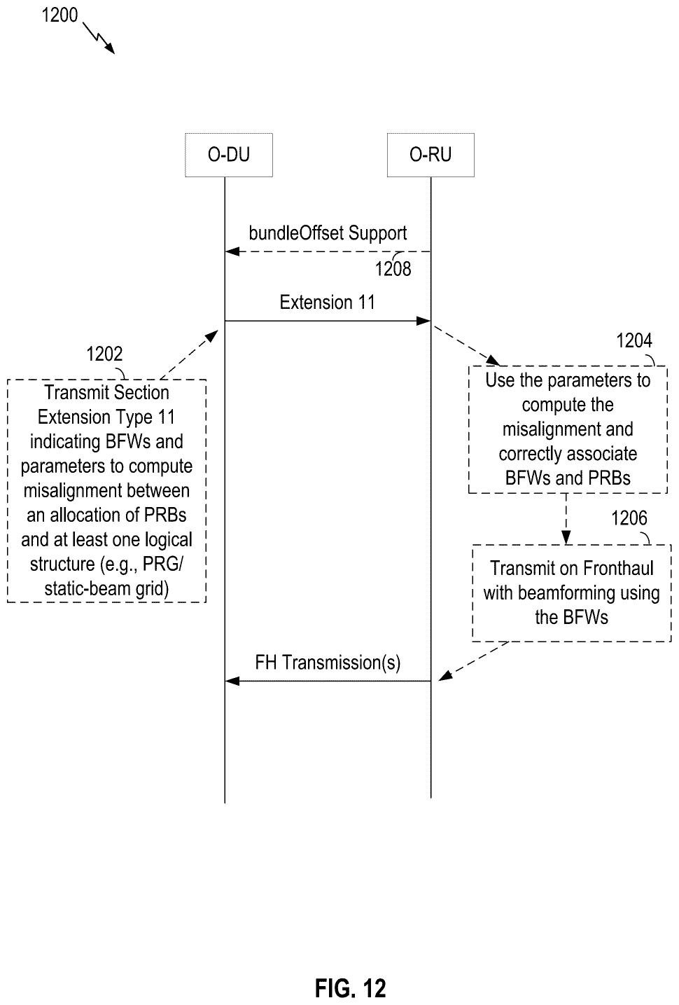

How the O-DU and O-RU utilize the capability may be understood with reference to the call flow diagram 1200 shown in FIG. 12. As shown at 1202, the O-DU may transmit a Section Extension Type 11 indicating BFWs and parameters to compute misalignment between an allocation of PRBs and at least one logical structure (e.g., PRG/static-beam grid). As shown at 1204, the O-RU may use the parameters to compute the misalignment and correctly associate BFWs and PRBs. As shown at 1206, the O-RU may use the parameters to compute the misalignment and correctly associate BFWs and PRBs for FH transmissions.

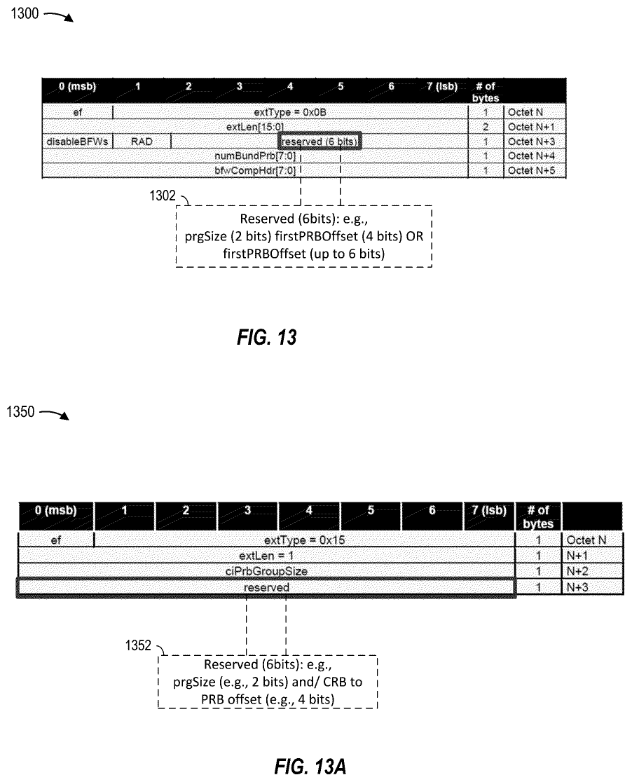

As noted above, for aligning the BFWs and PRBs, one or more new parameters may be introduced. In some cases, one or more of these parameters may be conveyed via section extension 11 (SE 11) information (numBundPrb). As illustrated at 1302 in FIG. 13, in some cases, (previously) reserved bits of an SE-11 structure 1300 may be used to signal one or more of these parameters. If an O-RU indicates support for such parameters (e.g., as illustrated at 1208 in FIG. 12), the O-DU may set the value of these bits accordingly to indicate the offset between the start of the first PRB bundle and the first PRB addressed by the section (startPrbc).

For example, assuming 6 bits are available, 2 bits may be used to signal a prgSize parameter that indicates the size of the PRGs, while 4-bits may be used to signal a firstPrbOffset parameter that indicates the offset between the first allocated PRB and the start of the PRG (if the prgSize parameter value is not equal to 0, indicating a narrowband) or the PRB Bundle (if the prgSize parameter is equal to 0, indicating wideband) that contains this first allocated PRB. In some cases, a 2-bit prgSize value may be: 0 (with a value of 0 meaning wideband), 2 or 4 (meaning a PRG size of 2 or 4 PRBs). In some cases, a 4-bit firstPrbOffset value can be in the range of [0 . . . 15], where a value of 0 may mean no misalignment. Of course, the available bits could be used in other ways, for example, as an entry in to a lookup table with entries corresponding to combinations of values for these parameters.

In some cases, only the firstPrbOffset may be signaled. This may be sufficient for the O-RU to determine misalignment, for example, if the PRG size is an integer value of the PRG size (e.g., if PRG size is 4, PRG size may need to be 1, 2, or 4), the prgSize parameter may not need to be signaled. Referring again to 1302 in FIG. 13, if only firstPrbOffset is signaled, all 6 reserved bits of an SE-11 structure 1300 may be used to signal firstPrbOffset.

Regardless of how they are signaled, using one or more of these parameters, the O-RU can compute the misalignment between the allocation and the PRG (or static BF grid) and correctly associate BFW and PRBs. In effect, as will be shown in the examples below, the parameters allow the network entities (O-RU and O-DU) to compute the misalignment between the RB allocation and the PRG/BF grid and to correctly associate BFW and PRBs. In effect, the parameters allow the network entities to determine the size of the first BF bundle which, as noted above, is impacted by the misalignment.

For allocation without discontinuities, the size of the first BF bundle may be redefined depending on whether the prgSize indicates wideband (prgSize==0) or indicates a narrowband (prgSize!=0). For example, if prgSize==0, the first BF bundle size may be defined as:

$$BF bundle size = numBundPrb - firstPrbOffset .$$

On the other hand, if prgSize!=0, the first BF bundle size may be defined as:

$$BF bundle size = numBundPrb - ( prgSize - firstPrbOffset ) \% numBundPrb .$$

If there are discontinuities in the PRB allocation, the RAD flag may be ignored at the O-RU and the O-DU may set it to 0. After each discontinuity, the PRG that includes the first PRB in the allocation may be referred to as a hosting PRG. The size of the hosting PRG can be computed as follows:

$$hostingPrgSize = prgSize - [ ( firstRbInBlock - ( firstRbInallocation - firstPrbOffset ) ) \% PrgSize ] ,$$

where firstRbInBlock refers to the first RB after a discontinuity and firstRbInAllocation is indicated by startPrbc. Once the hosting PRG size is known, the size of the first BF bundle after the discontinuity can be computed as follows:

$$BF bundle = numBundPrb - ( hostingPrgSize \% numBundPrb ) .$$

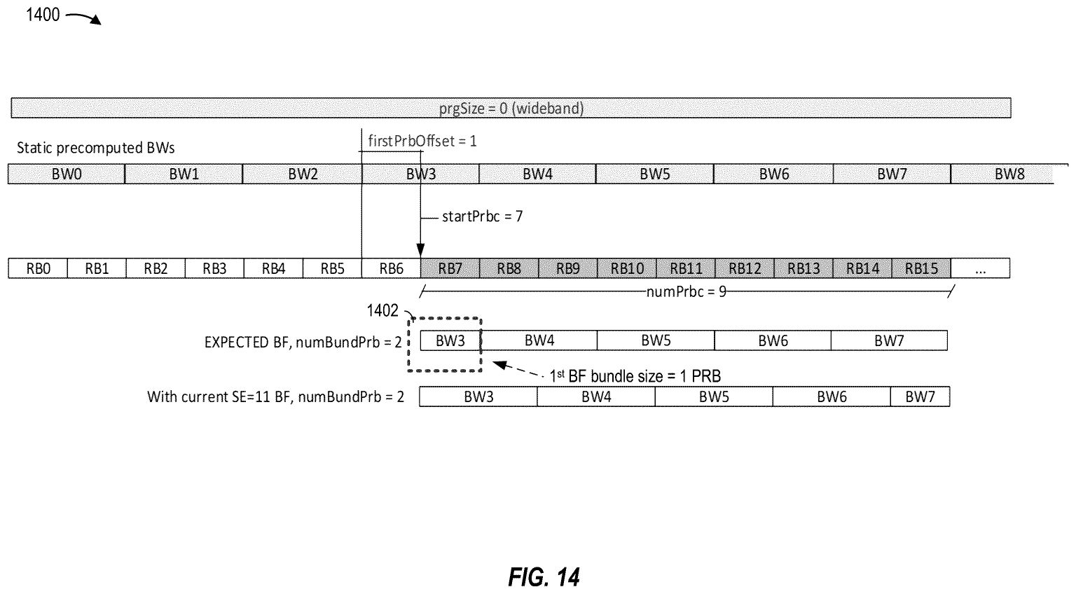

How these parameters may be used to determine the first BF bundle size in different scenarios may be understood with reference to the examples shown in FIGS. 14-19.

The example diagram 1400 of FIG. 14 assumes a wideband scenario (prgSize=0) and a static beam allocation with decimation by 2 (2 RBs). The example also assumes that startPrb=7 and firstPrbOffset=1. Thus, as shown at 1402, applying the equation above the first BF bundle size is computed as:

$$numBundPrb - firstPrbOffset = 2 - 1 = 1 PRB .$$

Thus, the O-RU may know that BW3 is to be applied to just RB7 (and not to RB8 also), resolving any ambiguity caused by the misalignment.

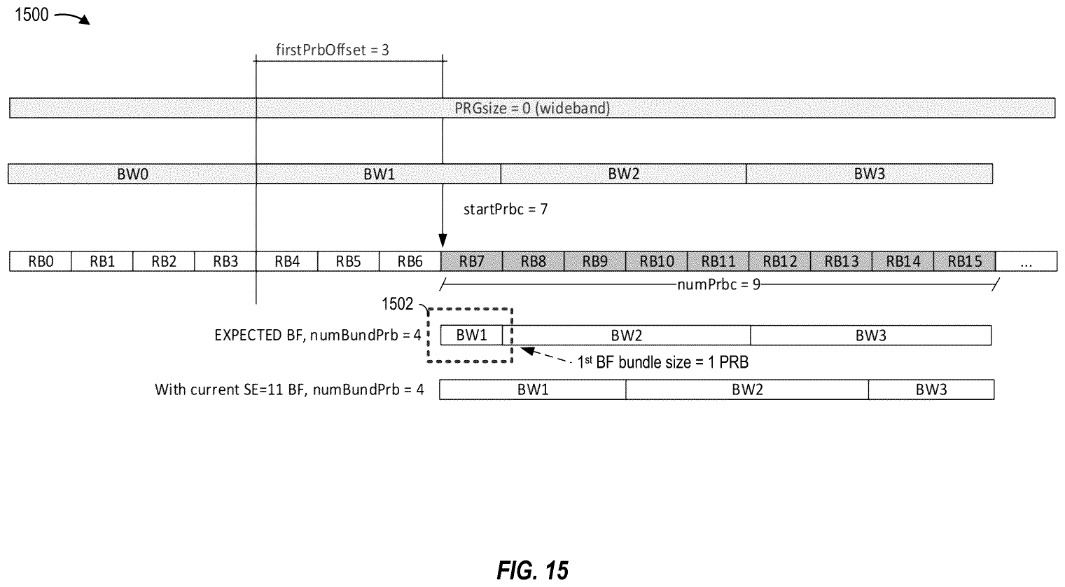

The example diagram 1500 of FIG. 15 also assumes a wideband scenario (prgSize=0), but with a static beam allocation with decimation by 4 (4 RBs). The example also assumes that startPrb=7 and firstPrbOffset=3. Thus, as shown at 1502, applying the equation above the first BF bundle size is computed as:

$$numBundPrb - firstPrbOffset = 4 - 3 = 1 PRB .$$

Thus, the O-RU may know that BW1 is to be applied to just RB7 (and not to RB8 or RB9 also), resolving any ambiguity caused by the misalignment.

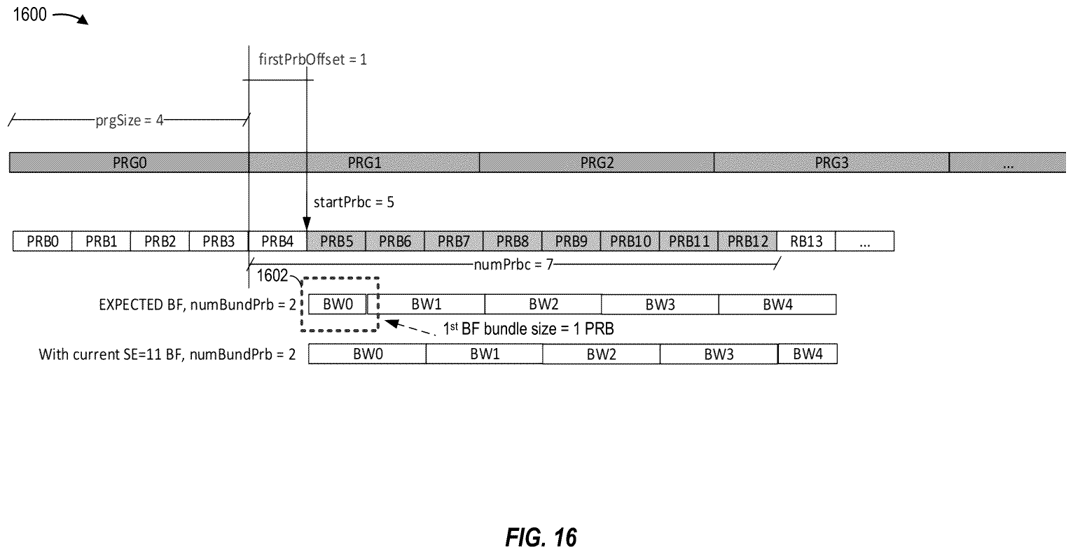

The example diagram 1600 of FIG. 16 assumes a narrowband scenario (prgSize=4), startPrb=5, and firstPrbOffset=1. Thus, as shown at 1602, applying the equation above the first BF bundle size is computed as:

$$numBundPrb - ( prgSize - firstPrbOffset ) \% numBundPrb = 2 - ( 4 - 1 ) \%2 = 1 PRB .$$

Thus, the O-RU may know that BW0 is to be applied to just PRB5 (and not to PRB6 also).

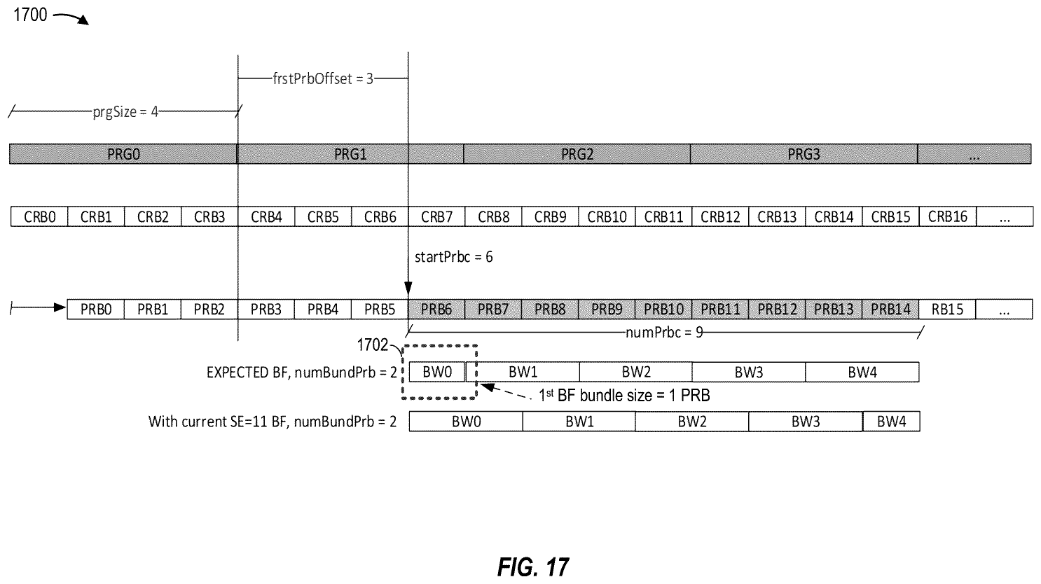

The example diagram 1700 of FIG. 17 assumes a narrowband scenario (prgSize=4), startPrb=6, and firstPrbOffset=3. Thus, as shown at 1702, applying the equation above the first BF bundle size is computed as:

$$numBundPrb - ( prgSize - firstPrbOffset ) \% numBundPrb = 2 - ( 4 - 3 ) \%2 = 1 PRB .$$

Thus, the O-RU may know that BW0 is to be applied to just PRB6 (and not to PRB7 also).

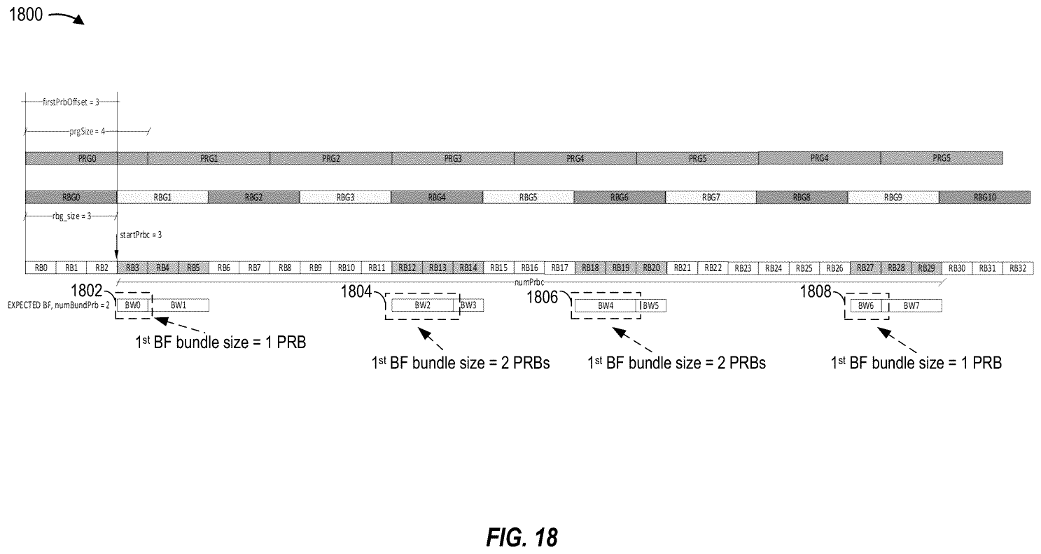

The example diagram 1800 of FIG. 18 illustrates a narrowband scenario with discontinuities. The example assumes prgSize=4, startPrbc=3, and firstPrbOffset=3, rbgSize=3, and an rbgMask=100101001b (indicating RBs in RBG1, RBG4, RGB6, and RBG9 are part of the allocation). Thus, applying the equations above, for the first RB block starting at RB3, the hosting PRG size is computed as:

$$hostingPrgSize = prgSize - [ ( firstRbInBlock - ( firstRbInallocation - firstPrbOffset ) ) \% PrgSize ] = 4 - [ ( 3 - ( 3 - 3 ) ) \%4 ) = 1 PRB .$$

As shown at 1802, given this hosting PRGSize, the first BF bundle size is computed as:

$$numBundPrb - ( hostingPrgSize \% numBundPrb ) = 2 - ( 1 \%2 ) = 1 PRB .$$

Thus, the O-RU may know that BW0 is to be applied to just RB3. For the second RB block starting at RB12, the hosting PRG size is computed as:

$$hostingPrgSize = prgSize - [ ( firstRbInBlock - ( firstRbInallocation - firstPrbOffset ) ) \% PrgSize ] = 4 - [ ( 12 - ( 3 - 3 ) ) \%4 ) = 4 PRB .$$

As shown at 1804, given this hosting PRGSize, the first BF bundle size is computed as:

$$numBundPrb - ( hostingPrgSize \% numBundPrb ) = 2 - ( 4 \%2 ) = 2 PRBs .$$

Thus, the O-RU may know that BW2 is to be applied to both RB12 and RB13. For the third RB block starting at RB18, the hosting PRG size is computed as:

$$hostingPrgSize = prgSize - [ ( firstRbInBlock - ( firstRbInallocation - firstPrbOffset ) ) \% PrgSize ] = 4 - [ ( 18 - ( 3 - 3 ) ) \%4 ) = 2 PRBs .$$

As shown at 1806, given this hosting PRGSize, the first BF bundle size is computed as:

$$numBundPrb - ( hostingPrgSize \% numBundPrb ) = 2 - ( 2 \% 2 ) = 2 PRBs .$$

Thus, the O-RU may know that BW4 is to be applied to both RB18 and RB19. For the fourth RB block starting at RB27, the hosting PRG size is computed as:

$$hostingPrgSize = prgSize - [ ( firstRbInBlock - ( firstRbInallocation - firstPrbOffset ) ) \% PrgSize ] = 4 - [ ( 27 - ( 3 - 3 ) ) \%4 ) = 1 PRB .$$

As shown at 1808, given this hosting PRGSize, the first BF bundle size is computed as:

$$numBundPrb - ( hostingPrgSize \% numBundPrb ) = 2 - ( 1 \% 2 ) = 1 PRB .$$

Thus, the O-RU may know that BW6 is to be applied to just RB27.

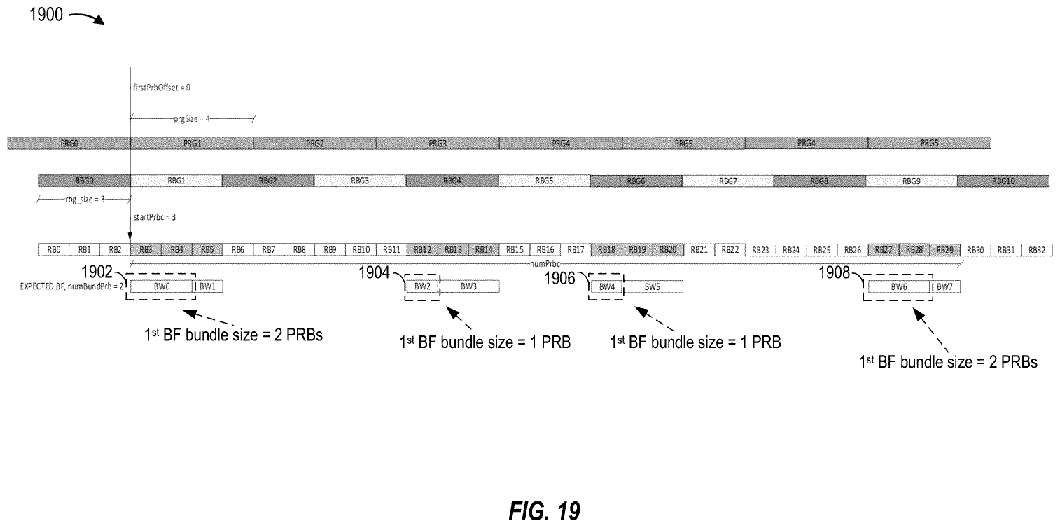

The example diagram 1900 of FIG. 19 illustrates another narrowband scenario with discontinuities. The example assumes prgSize=4, startPrbc=3, and firstPrbOffset=0, rbgSize=3, and the same rbgMask=100101001b as in the example of FIG. 18. Thus, applying the equations above, for the first RB block starting at RB3, the hosting PRG size is computed as:

$$hostingPrgSize = prgSize - [ ( firstRbInBlock - ( firstRbInallocation - firstPrbOffset ) ) \% PrgSize ] = 4 - [ ( 3 - ( 3 - 0 ) ) \%4 ) = 4 PRBs .$$

As shown at 1902, given this hosting PRGSize, the first BF bundle size is computed as:

$$numBundPrb - ( hostingPrgSize \% numBundPrb ) = 2 - ( 4 \% 2 ) = 2 PRBs .$$

Thus, the O-RU may know that BW0 is to be applied to both RB3 and RB4. For the second RB block starting at RB12, the hosting PRG size is computed as:

$$hostingPrgSize = prgSize - [ ( firstRbInBlock - ( firstRbInallocation - firstPrbOffset ) ) \% PrgSize ] = 4 - [ ( 12 - ( 3 - 0 ) ) \%4 ) = 3 PRBs .$$

As shown at 1904, given this hosting PRGSize, the first BF bundle size is computed as:

$$numBundPrb - ( hostingPrgSize \% numBundPrb ) = 2 - ( 3 \% 2 ) = 1 PRB .$$

Thus, the O-RU may know that BW2 is to be applied to just RB12. For the third RB block starting at RB18, the hosting PRG size is computed as:

$$hostingPrgSize = prgSize - [ ( firstRbInBlock - ( firstRbInallocation - firstPrbOffset ) ) \% PrgSize ] = 4 - [ ( 18 - ( 3 - 0 ) ) \%4 ) = 3 PRBs .$$

As shown at 1906, given this hosting PRGSize, the first BF bundle size is computed as:

$$numBundPrb - ( hostingPrgSize \% numBundPrb ) = 2 - ( 3 \% 2 ) = 1 PRB .$$

Thus, the O-RU may know that BW4 is to be applied to just RB18. For the fourth RB block starting at RB27, the hosting PRG size is computed as:

$$hostingPrgSize = prgSize - [ ( firstRbInBlock - ( firstRbInallocation - firstPrbOffset ) ) \% PrgSize ] = 4 - [ ( 27 - ( 3 - 0 ) ) \%4 ) = 4 PRBs .$$

As shown at 1908, given this hosting PRGSize, the first BF bundle size is computed as:

$$numBundPrb - ( hostingPrgSize \% numBundPrb ) = 2 - ( 4 \% 2 ) = 2 PRBs .$$

Thus, the O-RU may know that BW6 is to be applied to both RB27 and RB28.

In some cases, an O-RU may compute BFWs. For example, in the case of Channel Information based Beam Forming (CIBF), an O-RU computes BFWs based on channel estimations provided by an O-DU. In such cases, the O-RU may have flexibility to decide how to generate the BFWs and how to apply them. However, O-RU should be aware of PRG boundaries in case of narrow-band operation (N1, N2).

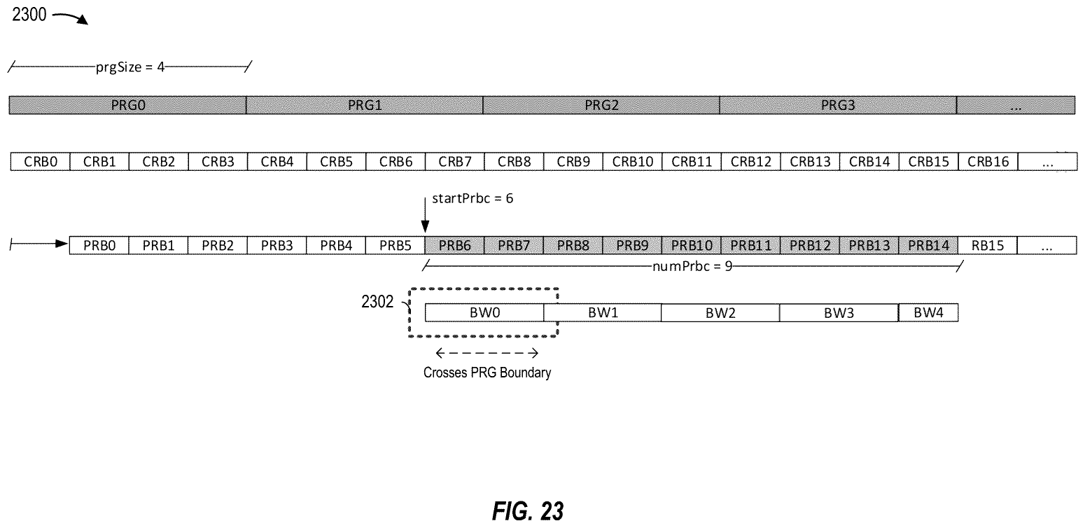

Similarly to the scenario described above with reference to the section extension 11, additional information may be provided to the O-RU from the Q-DU. This may be needed, for example, because the O-RU is not typically aware of the prgSize and possible misalignments between the PRBs and the common resource blocks (CRBs), which are the reference for PRG definition. CRBs generally refer to a set of contiguous physical resource blocks (PRBs) in the frequency domain that can be allocated to a user for transmission or reception of data. Diagram 2300 of FIG. 23 illustrates an example of misaligment between PRBs and CRBs that causes a BW (BW0) to cross PRG boundaries, as indicated at 2302.

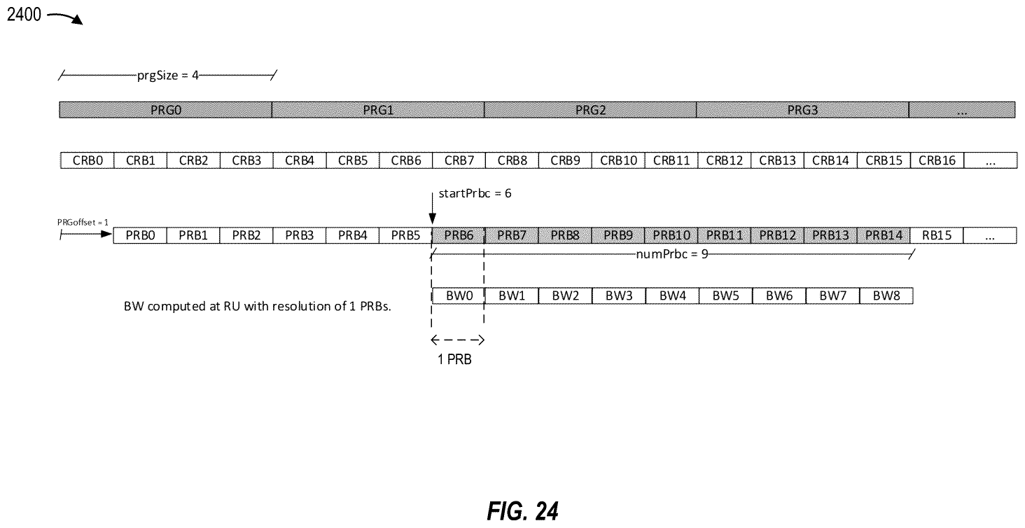

According one potential solution, illustrated in diagram 2400 of FIG. 24 O-RU generates always 1 BFW per RB. This solution may be less than optimal in some cases, because it may be relatively expensive in terms of computational power and processing overhead.

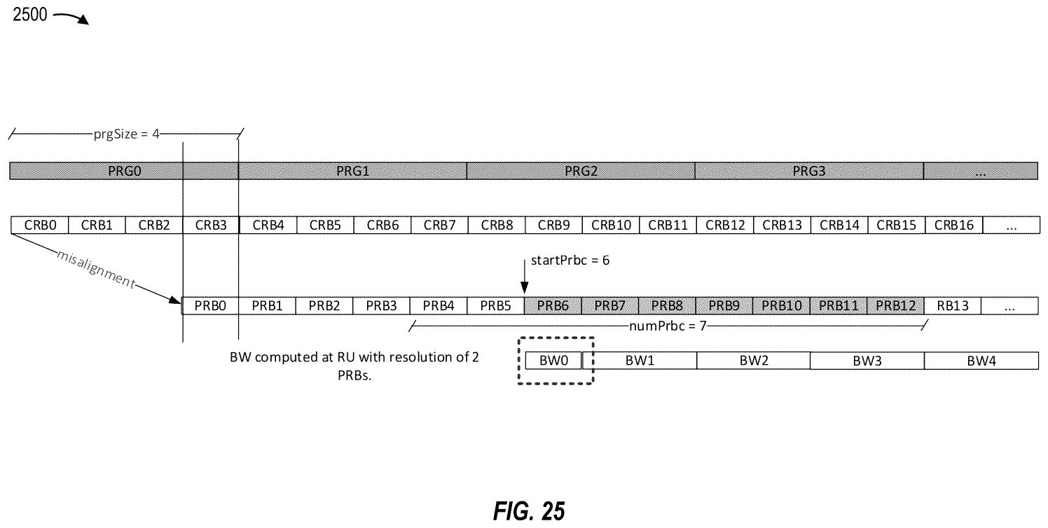

According to another potential solution, the O-DU may provide the O-RU with following parameters: prgSize and the CRB to PRB offset. The prgSize parameter may indicate 0, 1, or 2, with 0 indicating wideband while values 1 and 2 indicate narrowband cases (N1 and N2). The CRB to PRB offset may indicate CRB to PRB misalignment. As indicated in diagram 2500 of FIG. 25, the CRB to PRB offset may be indicated if there is a misalignment between the common resource block and the physical resource block. As indicated in 1352 of in FIG. 13A, in some cases one or more of these parameters may be conveyed using (previously) reserved bits of a section extension 21 (SE 21).

As illustrated in diagram 2600 of FIG. 26, the O-RU may compute how to realign the computation of BFWs and make sure that when it applies the BWs, they will not cross PRG boundaries. In the illustrated example, prgSize is 4 and the offset is 3. Given this information, the O-RU may apply the first BW (BW0) to just one PRB (PRB6). In some cases, the adjustment due to misalignment can then be computed as:

$$prgSize - ( misalignment \% prgSize ) .$$

In the example illustrated in FIG. 26, the adjustment is

$$prgSize = 4 - ( 3 \%4 ) = 1 .$$

In general, once the adjustment is known at the O-RU, it is possible to place any PRB on the right grid and compute a correct association between BFW and RBs. Thus, it may be left up to RU how to associate RBs and BFWs based on its capabilities (e.g. PRB resolution).

The misalignment may already be available to O-RU via an M-plane parameter (offset to carrier). However, the prgSize is typically not known at O-RU. Therefore, if the O-DU would provide to O-RU the prgSize this could aid the O-RU in computing BFWs in a manner that ensures that PRG boundaries are not crossed. As illustrated above in FIG. 13A, PrgSize could be passed as additional parameter in SE21, for example, using the reserved bits and by making SE21 usable (e.g., with Section Type=5 messages).

### Example Operations

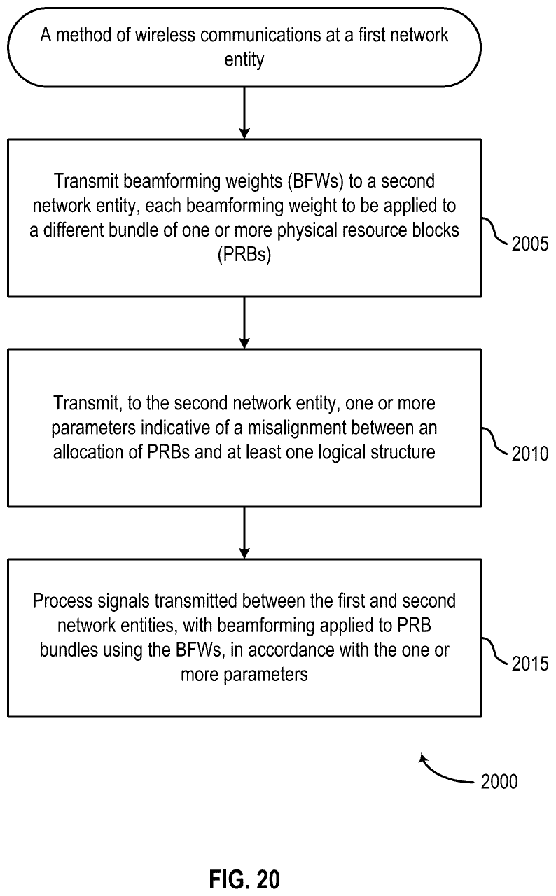

FIG. 20 shows an example of a method 2000 of wireless communications at a first network entity, such as a BS 102 of FIGS. 1 and 3, or a disaggregated base station as discussed with respect to FIG. 2.

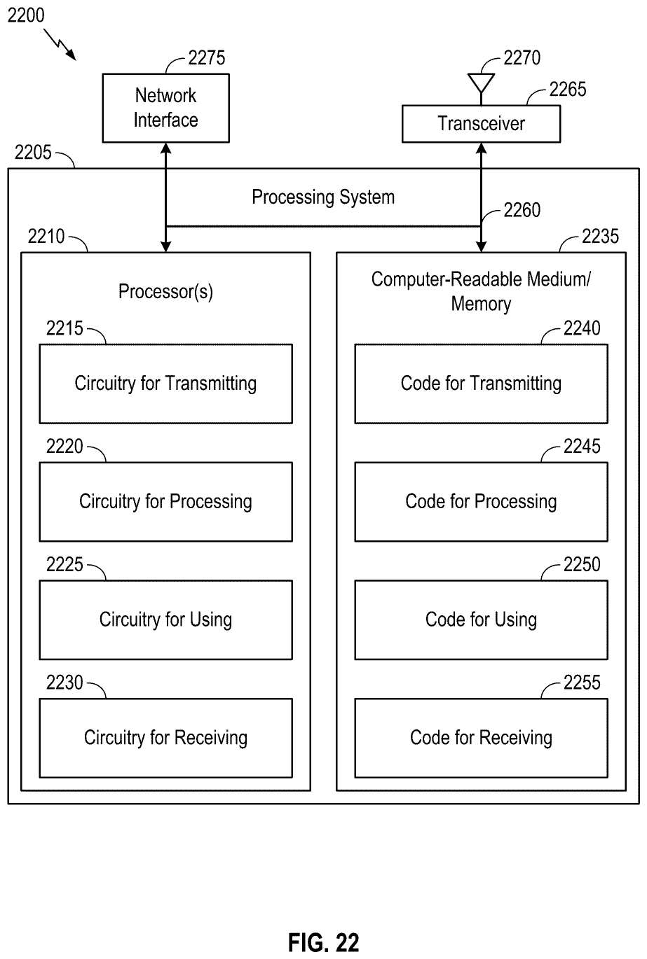

Method 2000 begins at step 2005 with transmitting beamforming weights (BFWs) to a second network entity, each beamforming weight to be applied to a different bundle of one or more physical resource blocks (PRBs). In some cases, the operations of this step refer to, or may be performed by, circuitry for transmitting and/or code for transmitting as described with reference to FIG. 22.

Method 2000 then proceeds to step 2010 with transmitting, to the second network entity, one or more parameters indicative of a misalignment between an allocation of PRBs and at least one logical structure. In some cases, the operations of this step refer to, or may be performed by, circuitry for transmitting and/or code for transmitting as described with reference to FIG. 22.

Method 2000 then proceeds to step 2015 with processing signals transmitted between the first and second network entities, with beamforming applied to PRB bundles using the BFWs, in accordance with the one or more parameters. In some cases, the operations of this step refer to, or may be performed by, circuitry for processing and/or code for processing as described with reference to FIG. 22.

In some aspects, the processing comprises receiving signals from the second network entity, with beamforming applied to PRB bundles using the BFWs, in accordance with the one or more parameters.

In some aspects, the logical structure comprises at least one of: a precoding resource block group (PRG) that represents a number of PRBs to which a same precoder is applied; or a BFW grid that maps BFWs to the allocation of PRBs.

In some aspects, the one or more parameters comprise: a first parameter that indicates a PRG size; and a second parameter that indicates an offset between a first allocated PRB and a start of a PRG or PRB bundle that contains the first allocated PRB.

In some aspects, the method 2000 further includes using the first and second parameters to determine a size of at least one beamforming (BF) bundle, wherein the processing assumes a first BFW is applied to at least one BF bundle of the determined size. In some cases, the operations of this step refer to, or may be performed by, circuitry for using and/or code for using as described with reference to FIG. 22.

In some aspects, the at least one BF bundle comprises a first BF bundle in the allocation of PRBs.

In some aspects, the first parameter indicates a wideband PRG size; and the size of the first BF bundle is determined as a difference between a configured PRB bundle size and the second parameter.

In some aspects, the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

In some aspects, the at least one BF bundle comprises a BF bundle after a discontinuity in the allocation of PRBs.

In some aspects, using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

In one aspect, method 2000, or any aspect related to it, may be performed by an apparatus, such as communications device 2200 of FIG. 22, which includes various components operable, configured, or adapted to perform the method 2000.

Communications device 2200 is described below in further detail.

Note that FIG. 20 is just one example of a method, and other methods including fewer, additional, or alternative steps are possible consistent with this disclosure.

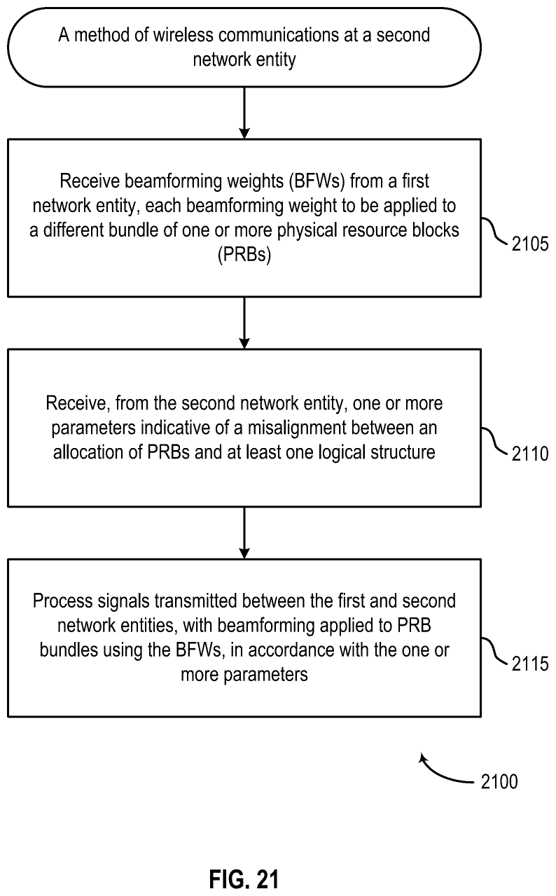

FIG. 21 shows an example of a method 2100 of wireless communications at a second network entity, such as a BS 102 of FIGS. 1 and 3, or a disaggregated base station as discussed with respect to FIG. 2.

Method 2100 begins at step 2105 with receiving beamforming weights (BFWs) from a first network entity, each beamforming weight to be applied to a different bundle of one or more physical resource blocks (PRBs). In some cases, the operations of this step refer to, or may be performed by, circuitry for receiving and/or code for receiving as described with reference to FIG. 22.

Method 2100 then proceeds to step 2110 with receiving, from the second network entity, one or more parameters indicative of a misalignment between an allocation of PRBs and at least one logical structure. In some cases, the operations of this step refer to, or may be performed by, circuitry for receiving and/or code for receiving as described with reference to FIG. 22.

Method 2100 then proceeds to step 2115 with processing signals transmitted between the first and second network entities, with beamforming applied to PRB bundles using the BFWs, in accordance with the one or more parameters. In some cases, the operations of this step refer to, or may be performed by, circuitry for processing and/or code for processing as described with reference to FIG. 22.

In some aspects, the processing comprises transmitting signals, to the first network entity, with beamforming applied to PRB bundles using the BFWs, in accordance with the one or more parameters.

In some aspects, the logical structure comprises at least one of: a precoding resource block group (PRG) that represents a number of PRBs to which a same precoder is applied; or a BFW grid that maps BFWs to the allocation of PRBs.

In some aspects, the one or more parameters comprise: a first parameter that indicates a PRG size; and a second parameter that indicates an offset between a first allocated PRB and a start of a PRG or PRB bundle that contains the first allocated PRB.

In some aspects, the method 2100 further includes using the first and second parameters to determine a size of at least one beamforming (BF) bundle, wherein the processing assumes a first BFW is applied to at least one BF bundle of the determined size. In some cases, the operations of this step refer to, or may be performed by, circuitry for using and/or code for using as described with reference to FIG. 22.

In some aspects, the at least one BF bundle comprises a first BF bundle in the allocation of PRBs.

In some aspects, the first parameter indicates a wideband PRG size; and the size of the first BF bundle is determined as a difference between a configured PRB bundle size and the second parameter.

In some aspects, the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

In some aspects, the at least one BF bundle comprises a BF bundle after a discontinuity in the allocation of PRBs.

In some aspects, using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

In one aspect, method 2100, or any aspect related to it, may be performed by an apparatus, such as communications device 2200 of FIG. 22, which includes various components operable, configured, or adapted to perform the method 2100. Communications device 2200 is described below in further detail.

Note that FIG. 21 is just one example of a method, and other methods including fewer, additional, or alternative steps are possible consistent with this disclosure.

### Example Communications Device(s)

FIG. 22 depicts aspects of an example communications device 2200. In some aspects, communications device 2200 is a network entity, such as BS 102 of FIGS. 1 and 3, or a disaggregated base station as discussed with respect to FIG. 2.

The communications device 2200 includes a processing system 2205 coupled to the transceiver 2265 (e.g., a transmitter and/or a receiver) and/or a network interface 2275. The transceiver 2265 is configured to transmit and receive signals for the communications device 2200 via the antenna 2270, such as the various signals as described herein. The network interface 2275 is configured to obtain and send signals for the communications device 2200 via communication link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210. In various aspects, one or more processors 2210 may be representative of one or more of receive processor 338, transmit processor 320, TX MIMO processor 330, and/or controller/processor 340, as described with respect to FIG. 3. The one or more processors 2210 are coupled to a computer-readable medium/memory 2235 via a bus 2260. In certain aspects, the computer-readable medium/memory 2235 is configured to store instructions (e.g., computer-executable code) that when executed by the one or more processors 2210, cause the one or more processors 2210 to perform the method 2000 described with respect to FIG. 20, or any aspect related to it; and the method 2100 described with respect to FIG. 21, or any aspect related to it. Note that reference to a processor of communications device 2200 performing a function may include one or more processors 2210 of communications device 2200 performing that function.

In the depicted example, the computer-readable medium/memory 2235 stores code (e.g., executable instructions), such as code for transmitting 2240, code for processing 2245, code for using 2250, and code for receiving 2255. Processing of the code for transmitting 2240, code for processing 2245, code for using 2250, and code for receiving 2255 may cause the communications device 2200 to perform the method 2000 described with respect to FIG. 20, or any aspect related to it; and the method 2100 described with respect to FIG. 21, or any aspect related to it.

The one or more processors 2210 include circuitry configured to implement (e.g., execute) the code stored in the computer-readable medium/memory 2235, including circuitry such as circuitry for transmitting 2215, circuitry for processing 2220, circuitry for using 2225, and circuitry for receiving 2230. Processing with circuitry for transmitting 2215, circuitry for processing 2220, circuitry for using 2225, and circuitry for receiving 2230 may cause the communications device 2200 to perform the method 2000 described with respect to FIG. 20, or any aspect related to it; and the method 2100 described with respect to FIG. 21, or any aspect related to it.

Various components of the communications device 2200 may provide means for performing the method 2000 described with respect to FIG. 20, or any aspect related to it; and the method 2100 described with respect to FIG. 21, or any aspect related to it. Means for transmitting, sending or outputting for transmission may include transceivers 332 and/or antenna(s) 334 of the BS 102 illustrated in FIG. 3 and/or the transceiver 2265 and the antenna 2270 of the communications device 2200 in FIG. 22. Means for receiving or obtaining may include transceivers 332 and/or antenna(s) 334 of the BS 102 illustrated in FIG. 3 and/or the transceiver 2265 and the antenna 2270 of the communications device 2200 in FIG. 22.

### Example Clauses

Implementation examples are described in the following numbered clauses:

Clause 1: A method of wireless communications at a first network entity, comprising: transmitting beamforming weights (BFWs) to a second network entity, each beamforming weight to be applied to a different bundle of one or more physical resource blocks (PRBs); transmitting, to the second network entity, one or more parameters indicative of a misalignment between an allocation of PRBs and at least one logical structure; and processing signals transmitted between the first and second network entities, with beamforming applied to PRB bundles using the BFWs, in accordance with the one or more parameters.

Clause 2: The method of Clause 1, wherein the processing comprises receiving signals from the second network entity, with beamforming applied to PRB bundles using the BFWs, in accordance with the one or more parameters.

Clause 3: The method of any one of Clauses 1-2, wherein the logical structure comprises at least one of: a precoding resource block group (PRG) that represents a number of PRBs to which a same precoder is applied; or a BFW grid that maps BFWs to the allocation of PRBs.

Clause 4: The method of Clause 3, wherein the one or more parameters comprise: a first parameter that indicates a PRG size; and a second parameter that indicates an offset between a first allocated PRB and a start of a PRG or PRB bundle that contains the first allocated PRB.

Clause 5: The method of Clause 4, further comprising: using the first and second parameters to determine a size of at least one beamforming (BF) bundle, wherein the processing assumes a first BFW is applied to at least one BF bundle of the determined size.

Clause 6: The method of Clause 5, wherein the at least one BF bundle comprises a first BF bundle in the allocation of PRBs.

Clause 7: The method of Clause 6, wherein: the first parameter indicates a wideband PRG size; and the size of the first BF bundle is determined as a difference between a configured PRB bundle size and the second parameter.

Clause 8: The method of Clause 6, wherein: the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

Clause 9: The method of Clause 5, wherein the at least one BF bundle comprises a BF bundle after a discontinuity in the allocation of PRBs.

Clause 10: The method of Clause 9, wherein using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

Clause 11: A method of wireless communications at a second network entity, comprising: receiving beamforming weights (BFWs) from a first network entity, each beamforming weight to be applied to a different bundle of one or more physical resource blocks (PRBs); receiving, from the second network entity, one or more parameters indicative of a misalignment between an allocation of PRBs and at least one logical structure; and processing signals transmitted between the first and second network entities, with beamforming applied to PRB bundles using the BFWs, in accordance with the one or more parameters.

Clause 12: The method of Clause 11, wherein the processing comprises transmitting signals, to the first network entity, with beamforming applied to PRB bundles using the BFWs, in accordance with the one or more parameters.

Clause 13: The method of any one of Clauses 11-12, wherein the logical structure comprises at least one of: a precoding resource block group (PRG) that represents a number of PRBs to which a same precoder is applied; or a BFW grid that maps BFWs to the allocation of PRBs.

Clause 14: The method of Clause 13, wherein the one or more parameters comprise: a first parameter that indicates a PRG size; and a second parameter that indicates an offset between a first allocated PRB and a start of a PRG or PRB bundle that contains the first allocated PRB.

Clause 15: The method of Clause 14, further comprising: using the first and second parameters to determine a size of at least one beamforming (BF) bundle, wherein the processing assumes a first BFW is applied to at least one BF bundle of the determined size.

Clause 16: The method of Clause 15, wherein the at least one BF bundle comprises a first BF bundle in the allocation of PRBs.

Clause 17: The method of Clause 16, wherein: the first parameter indicates a wideband PRG size; and the size of the first BF bundle is determined as a difference between a configured PRB bundle size and the second parameter.

Clause 18: The method of Clause 16, wherein: the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

Clause 19: The method of Clause 15, wherein the at least one BF bundle comprises a BF bundle after a discontinuity in the allocation of PRBs.

Clause 20: The method of Clause 19, wherein using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

Clause 21: An apparatus, comprising: a memory comprising executable instructions; and a processor configured to execute the executable instructions and cause the apparatus to perform a method in accordance with any one of Clauses 1-20.

Clause 22: An apparatus, comprising means for performing a method in accordance with any one of Clauses 1-20.

Clause 23: A non-transitory computer-readable medium comprising executable instructions that, when executed by a processor of an apparatus, cause the apparatus to perform a method in accordance with any one of Clauses 1-20.

Clause 24: A computer program product embodied on a computer-readable storage medium comprising code for performing a method in accordance with any one of Clauses 1-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications at a first network entity, comprising:
at least one processor;
at least one memory coupled with the processor; and
instructions stored in the memory and executable by the processor to cause the apparatus to:
transmit beamforming weights (BFWs) to a second network entity, each beamforming weight to be applied to a different bundle of one or more physical resource blocks (PRBs);
transmit, to the second network entity, one or more parameters indicative of a misalignment between an allocation of PRBs and at least one logical structure; and
process signals transmitted between the first and second network entities, with beamforming applied to PRB bundles using the BFWs, in accordance with the one or more parameters.

2. The apparatus of claim 1, wherein the processing comprises receiving signals from the second network entity, with beamforming applied to PRB bundles using the BFWs, in accordance with the one or more parameters.

3. The apparatus of claim 1, wherein the logical structure comprises at least one of: a precoding resource block group (PRG) that represents a number of PRBs to which a same precoder is applied; or a BFW grid that maps BFWs to the allocation of PRBs.

4. The apparatus of claim 3, wherein the one or more parameters comprise at least one of: a first parameter that indicates a PRG size; or a second parameter that indicates an offset between a first allocated PRB and a start of a PRG or PRB bundle that contains the first allocated PRB.

5. The apparatus of claim 4, wherein the instructions are further executable by the processor to cause the apparatus to:
use the first and second parameters to determine a size of at least one beamforming (BF) bundle, wherein the processing assumes a first BFW is applied to at least one BF bundle of the determined size.

6. The apparatus of claim 5, wherein the at least one BF bundle comprises a first BF bundle in the allocation of PRBs.

7. The apparatus of claim 6, wherein: the first parameter indicates a wideband PRG size; and the size of the first BF bundle is determined as a difference between a configured PRB bundle size and the second parameter.

8. The apparatus of claim 6, wherein: the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

9. The apparatus of claim 5, wherein the at least one BF bundle comprises a BF bundle after a discontinuity in the allocation of PRBs.

10. The apparatus of claim 9, wherein using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

11. An apparatus for wireless communications at a second network entity, comprising:
at least one processor;
at least one memory coupled with the processor; and
instructions stored in the memory and executable by the processor to cause the apparatus to:
receive beamforming weights (BFWs) from a first network entity, each beamforming weight to be applied to a different bundle of one or more physical resource blocks (PRBs);
receive, from the second network entity, one or more parameters indicative of a misalignment between an allocation of PRBs and at least one logical structure; and
process signals transmitted between the first and second network entities, with beamforming applied to PRB bundles using the BFWs, in accordance with the one or more parameters.

12. The apparatus of claim 11, wherein the processing comprises transmitting signals, to the first network entity, with beamforming applied to PRB bundles using the BFWs, in accordance with the one or more parameters.

13. The apparatus of claim 11, wherein the logical structure comprises at least one of: a precoding resource block group (PRG) that represents a number of PRBs to which a same precoder is applied; or a BFW grid that maps BFWs to the allocation of PRBs.

14. The apparatus of claim 13, wherein the one or more parameters comprise: a first parameter that indicates a PRG size; and a second parameter that indicates an offset between a first allocated PRB and a start of a PRG or PRB bundle that contains the first allocated PRB.

15. The apparatus of claim 14, the instructions are further executable by the processor to cause the apparatus to:
use the first and second parameters to determine a size of at least one beamforming (BF) bundle, wherein the processing assumes a first BFW is applied to at least one BF bundle of the determined size.

16. The apparatus of claim 15, wherein the at least one BF bundle comprises a first BF bundle in the allocation of PRBs.

17. The apparatus of claim 16, wherein: the first parameter indicates a wideband PRG size; and the size of the first BF bundle is determined as a difference between a configured PRB bundle size and the second parameter.

18. The apparatus of claim 16, wherein: the first parameter indicates an integer PRG size; and the size of the first BF bundle is determined as a difference between: a configured PRB bundle size and the second parameter; and a modulus function applied to a difference between the first parameter and the second parameter, and the configured PRB bundle size.

19. The apparatus of claim 15, wherein the at least one BF bundle comprises a BF bundle after a discontinuity in the allocation of PRBs.

20. The apparatus of claim 19, wherein using the first and second parameters to determine the size of the BF bundle after the discontinuity comprises: using the first and second parameters to determine a size of a hosting PRG; and using the size of the hosting PRG and a configured PRB bundle size to determine the size of the BF bundle after the discontinuity.

21. An apparatus for wireless communications at a first network entity, comprising:
at least one processor;
at least one memory coupled with the processor; and
instructions stored in the memory and executable by the processor to cause the apparatus to:
transmit, to a second network entity, one or more parameters to account for a misalignment between an allocation of physical resource blocks (PRBs) and at least one logical structure; and
process signals transmitted between the first and second network entities, with beamforming applied to PRB bundles using the beamforming weights (BFWs), in accordance with the one or more parameters.

22. An apparatus for wireless communications at a first network entity, comprising:
at least one processor;
at least one memory coupled with the processor; and
instructions stored in the memory and executable by the processor to cause the apparatus to:
receive, from a first network entity, one or more parameters to account for a misalignment between an allocation of physical resource blocks (PRBs) and at least one logical structure; and
process signals transmitted between the first and second network entities, with beamforming applied to PRB bundles using the BFWs, in accordance with the one or more parameters.
